(19) United States
(12) Patent Application Publication
(10) Pub. No.: US 2007/0040629 A1
(43) Pub. Date: Feb. 22, 2007

(54) Nrd guide converter and connected structure of dielectric and conductor

(76) Inventors: Tsukasa Yoneyama, Miyagi (JP); Futoshi Kuroki, Hiroshima (JP); Hirokazu Sawada, Miyagi (JP)

Correspondence Address: YOUNG & THOMPSON, 745 SOUTH 23RD STREET, 2ND FLOOR, ARLINGTON, VA, 22202, US

(21) Appl. No.: 10/556,911

(22) PCT Filed: May 17, 2004
(86) PCT No.: PCT/JP04/06973

§ 371 Date: Jul. 13, 2006

(30) Foreign Application Priority Data
May 16, 2003 (JP) 2003-139558
Sep. 19, 2003 (JP) 2003-328017

(51) Int. Cl. H01P 5/107

(52) U.S. Cl. 333/26; 333/248

(57) ABSTRACT

In order to realize with a low loss a hybrid structure in which an NRD guide is used for a transmission part and a microstrip line is used for a circuit element loading part, the present device includes: a dielectric waveguide (1) which is sandwiched between parallel conductor plates and has a gap which is less than a ½ wavelength; a microstrip line (4) which is provided on a side surface of a metal rod (3) opposite to the dielectric waveguide (1), the metal rod (3) being adjacently arranged in parallel with the dielectric waveguide (1); and a coaxial line (5) which pierces the metal rod (3) and connects the dielectric waveguide (1) with the microstrip line (4).

### TECHNICAL FIELD

The present invention relates to an NRD guide transition which connects an NRD guide (Nonradiative Dielectric Waveguide) having a very small transmission loss with a microstrip line capable of flexibly constituting various kinds of circuits, and a coupling structure of a general dielectric material and a conductor including coupling of the dielectric waveguide and a conductor or coupling of a dielectric material and a conductor in coupling of a microstrip line and a coaxial line.

### BACKGROUND ART

In recent years, realization of ultrahigh-speed/high-capacity wireless communication has been strongly demanded, and utilization of a millimeter-wave band is useful for realization of this communication. In particular, development of a broadband circuit element, which does not require a license and covers a 59- to 66-GHz band, is important. With this development, it is possible to realize an ultrahigh-speed wireless LAN, a home link, TV indoor wireless transfer, an inter-vehicle communication system and others at a transmission rate exceeding, e.g., 400 Mbps.

As such a millimeter-wave or microwave transmission circuit, an NRD guide has been conventionally used. In this NRD guide, as shown in FIG. 11, a dielectric waveguide 101 formed of, e.g., Teflon (a registered trademark) having, e.g., a dielectric constant εr=2.04 is provided between a pair of parallel conductor plates 102a and 102b. A width of each of these conductor plates 102a and 102b, i.e., a height of the dielectric waveguide 101 is set to be less than a ½ wavelength of a frequency of a millimeter wave, and a width of the dielectric waveguide 101 is set to be approximately a ½ wavelength. For example, if an operating frequency is 60 GHz, a height of the dielectric waveguide 101 is set to 2.25 mm and a width of the dielectric waveguide 101 is set to 2.5 mm. As a result, a millimeter wave having the operating frequency can be propagated through the dielectric waveguide 101, but the millimeter wave having the operating frequency cannot be propagated outside the dielectric waveguide 101, and hence the millimeter wave is trapped in and transmitted through the dielectric waveguide 101.

Although such an electric field in a cross section as shown in FIG. 11 is generated in an operating mode (an LSM mode) of the millimeter wave transmitted through this dielectric waveguide, an LSE mode which is an unnecessary parasitic mode is produced as shown in FIG. 12 when the dielectric waveguide 101 bends or branches between the pair of conductor plates 102a and 102b.

In order to suppress this LSE mode, a mode suppressor 103 having a ¼ wavelength choke structure is inserted into the dielectric waveguide 101 in the prior art as shown in FIG. 15 (see Japanese Patent Application Laid-open No. 2000-341003).

However, in case of inserting the above-described conventional mode suppressor 103 into the dielectric waveguide 101, there is a problem requiring a troublesome operation which takes time and labor, namely, the once-created dielectric waveguide 101 is cut open in a longitudinal direction, and the mode suppressor 103 is inserted into and attached to this cut portion. Thus, the present inventors have discovered that arranging a conductor in the vicinity of or in close contact with the dielectric waveguide 101 can effectively control the LSE mode, which is a parasitic mode (see Japanese Patent Application No. 2003-49953).

In a case where the dielectric contact 101 is brought into contact with the conductor, however, there is a problem that transmission characteristics may not be possibly obtained as designed and irregularities in the transmission characteristics are large.

Further, in a circuit using an NRD guide, a microstrip line may be also used in some cases, and coupling the NRD guide with the microstrip line through a coaxial line can reduce deterioration in the transmission characteristics in this case. However, there is a problem that the transmission characteristics may not be possibly obtained as designed in coupling of the microstrip line and the coaxial line and irregularities in the transmission characteristics are large.

Here, this NRD guide has excellent characteristics that a transmission loss is very low in a millimeter-wave band as described above and radiation of an unnecessary millimeter wave is not generated at all in a bent part or a discontinuous part of the dielectric waveguide. However, the NRD guide is suitable for loading a two-terminal element such as a diode, but has a problem that it is not suitable for loading a three-terminal element.

On the other hand, the microstrip line is suitable for loading of a three-terminal element or the like, and can constitute various kinds of flexible circuits. However, the microstrip line has a problem that it demonstrates a large transmission loss in a millimeter-wave band.

Thus, there can be considered a hybrid structure in which the NRD guide is used for a transmission part and the microstrip line is used for a circuit element loading part such as a three-terminal element, but there is a problem that the NRD guide and the microstrip line cannot be efficiently coupled.

In view of the above-described problems, it is an object of the present invention to provide an NRD guide transition capable of realizing with a low loss a hybrid structure in which an NRD guide is used for a transmission part and a microstrip line is used for a circuit element loading part, and provide a coupling structure of a dielectric material and a conductor capable of assuredly obtaining designed transmission characteristics with a simple configuration.

### DISCLOSURE OF THE INVENTION

To this end, an NRD guide transition according to the present invention is characterized by comprising: a dielectric waveguide which is sandwiched between parallel conductor plates and has a height which is less than a ½ wavelength; a microstrip line which is provided on a side surface of a conductor rod opposite to the dielectric waveguide, the conductor rod being adjacently arranged in substantially parallel with the dielectric waveguide; and a coaxial line which pierces the conductor rod and connects the dielectric waveguide with the microstrip line.

Further, an NRD guide transition according to the present invention is characterized by comprising: a first dielectric waveguide which is sandwiched between parallel conductor plates and has a height which is less than a ½ wavelength; a second dielectric waveguide which is cascade-arranged with respect to the first dielectric waveguide in a longitudinal direction; a microstrip line which is provided on a side surface of a conductor rod opposite to the first and second dielectric waveguides, the conductor rod being adjacently arranged in substantially parallel with the first and second dielectric waveguides; a first coaxial line which pierces the conductor rod in the vicinity of one end portion thereof, and connects the first dielectric waveguide with the vicinity of one end portion of the microstrip line; and a second coaxial line which pierces the conductor rod in the vicinity of the other end portion thereof, and connects the second dielectric waveguide with the vicinity of the other end portion of the microstrip line, wherein the first dielectric waveguide, the microstrip line and the second dielectric waveguide are cascade-connected.

Furthermore, an NRD guide transition according to present invention is characterized by comprising: first and second dielectric waveguides each of which is sandwiched between parallel conductor plates and has a height which is less than a ½ wavelength; rst and second conductor rods which are provided between the first and second dielectric waveguides and arranged in substantially parallel with the first and second dielectric waveguides; a microstrip line provided between the first and second conductor rods; a first coaxial line which pierces the first conductor rod and connects the first dielectric waveguide with one end of the microstrip line; and a second coaxial line which pierces the second conductor rod and connects the second dielectric waveguide with the other end of the microstrip line, wherein the first dielectric waveguide, the microstrip line and the second dielectric waveguide are cascade-connected.

Moreover, in the above-described invention, the NRD guide transition according to the present invention is characterized by further comprising: a first vertical strip line which connects one end of the first coaxial line connected with the first dielectric waveguide to the first dielectric waveguide; and a second vertical strip line which connects one end of the second coaxial line connected with the second dielectric waveguide to the second dielectric waveguide.

Additionally, in the above-described invention, the NRD guide transition according to the present invention is characterized in that each of the conductor rod, the first conductor rod and the second conductor rod has a ¼ wavelength choke structure formed on upper and lower surfaces thereof.

Further, in the above-described invention, the NRD guide transition according to the present invention is characterized in that a liquid dielectric material is filled on contact surfaces of the first and second coaxial lines and the microstrip line.

Furthermore, in the above-described invention, the NRD guide transition according to the present invention is characterized in that the liquid dielectric material is a liquid dielectric material having dry curing properties.

Moreover, in the above-described invention, the NRD guide transition according to the present invention is characterized in that the liquid dielectric material having dry curing properties is enamel.

Additionally, in the above-described invention, a coupling structure of a dielectric material and a conductor according to the present invention is characterized in that, in the coupling structure of a dielectric material and a conductor in which an inner conductor of a coaxial line pierces a dielectric substrate of a microstrip line and the microstrip line is coupled with the coaxial line, a liquid dielectric material is filled on contact surfaces of the inner conductor and the dielectric substrate. Further, a coupling structure of a dielectric material and a conductor according to the present invention is characterized in that a conductor is arranged to be appressed against a dielectric waveguide of an NRD guide, and a liquid dielectric material is filled between the dielectric waveguide and the conductor, the dielectric waveguide being sandwiched between parallel conductor plates and having a gap which is less than a ½ wavelength, the NRD guide propagating a millimeter wave through the dielectric waveguide.

Furthermore, in the above-described invention, the coupling structure of a dielectric material and a conductor according to the present invention is characterized in that the liquid dielectric material is a liquid dielectric material having dry curing properties.

Moreover, in the above-described invention, the coupling structure of a dielectric material and a conductor is characterized in that the liquid dielectric material having dry curing properties is enamel.

### BRIEF DESCRIPTION OF THE DRAWINGS

FIG. 1 is a partially cutaway perspective view showing an NRD guide transition according to Embodiment 1 of the present invention;

FIG. 2 is a plan view showing a primary part of the NRD guide transition depicted in FIG. 1;

FIG. 3 is a view showing frequency characteristics of a transition output and a return loss of the NRD guide transition depicted in FIG. 1;

FIG. 4 is a plan view showing a primary part of an NRD guide transition according to Embodiment 2 of the present invention;

FIG. 5 is a view showing frequency characteristics of a transition output and a return loss of the NRD guide transition depicted in FIG. 4;

FIG. 6 is a partially cutaway perspective view of an NRD guide transition according to Embodiment 3 of the present invention;

FIG. 7 is a partially cutaway perspective view showing a modification of the NRD guide transition according to Embodiment 3 of the present invention;

FIG. 8 is a partially cutaway view obliquely showing a coupling structure of a microstrip line and a coaxial line according to Embodiment 4 of the present invention;

FIG. 9 is a view showing a difference in transmission characteristics depending on presence/absence of enamel filling;

FIG. 10 is a partially cutaway view obliquely showing a general configuration of an NRD guide mode suppressor according to Embodiment 5 of the present invention;

FIG. 11 is a view showing an electric field distribution of an operating mode;

FIG. 12 is a view showing an electric field distribution of a parasitic mode;

FIG. 13 is a view showing a change in an electromagnetic field distribution involved by bending of the NRD guide;

FIG. 14 is a view showing a difference in transmission characteristics depending on presence/absence of enamel filling; and

FIG. 15 is a schematic view showing a configuration of a conventional NRD guide mode suppressor.

### BEST MODE FOR CARRYING OUT THE INVENTION

Preferred embodiments of an NRD guide transition and a coupling structure of a dielectric material and a conductor according to the present invention will now be described in detail hereinafter with reference to the accompanying drawings.

### Embodiment 1

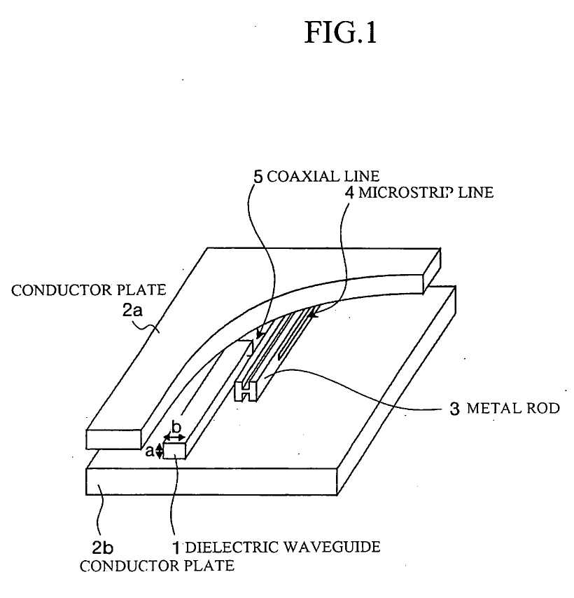

FIG. 1 is a partially cutaway perspective view showing an NRD guide transition according to Embodiment 1 of the present invention. In FIG. 1, this NRD guide transition has a dielectric waveguide 1 sandwiched between parallel conductor plates 2a and 2b, and a metal rod 3 as a conductor, which is arranged in close proximity to and parallel with this dielectric waveguide 1. A microstrip line 4 is formed on a side surface of this metal rod 3 opposite to the dielectric waveguide 1 side. Since a coaxial line 5 can be readily connected with the dielectric waveguide 1 and also easily connected with the microstrip line 4, the dielectric waveguide 1 is connected with the microstrip line 4 through the coaxial line 5. It is to be noted that the metal rod 3 is sandwiched between the conductor plates 2a and 2b like the dielectric waveguide 1. Further, the dielectric waveguide 1 is realized by Teflon (a registered trademark) having a relative dielectric constant εr=2.04, tan δ=approximately 1.5×10⁻⁴, and has a height a of 2.25 mm and a width b of 2.5 mm. Assuming that an operating frequency of a millimeter wave propagated through the dielectric waveguide 1 is 60 GHz, its wavelength λ is approximately 5 mm, the height a becomes not smaller than a ½ wavelength, and a millimeter wave having the operating frequency is not propagated between the conductor plates 2a and 2b excluding the dielectric waveguide 1. On the contrary, in the dielectric waveguide 1, a wavelength is reduced, and the millimeter wave having the operating frequency can be propagated. As a result, there is formed an NRD guide in which the millimeter wave is propagated through the dielectric waveguide 1 alone in the operating frequency band.

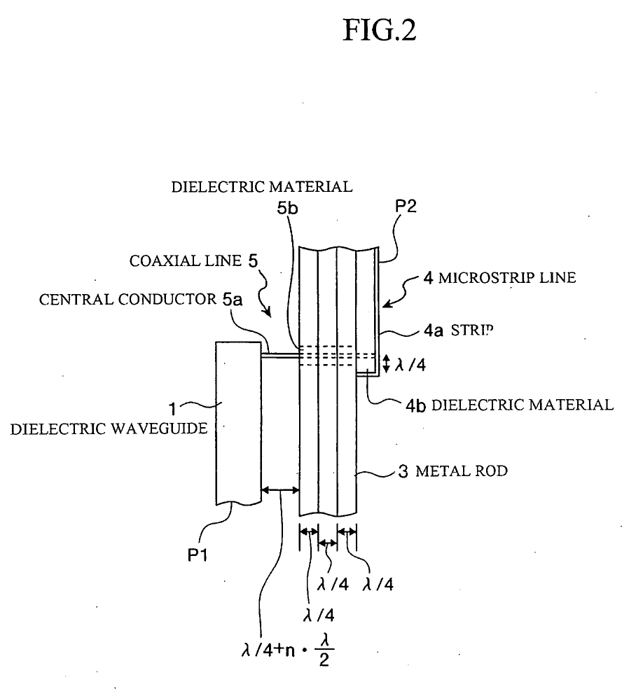

Here, a configuration in the vicinity of the coaxial line 5 will now be described with reference to FIG. 2. In FIG. 2, a cylindrical hole is provided in the metal rod 3, a dielectric material 5b realized by Teflon (a registered trademark) or the like is filled in this hole, and a central conductor 5a pierces through an axis of this dielectric material 5b, thereby forming the coaxial line 5. One end of the central conductor 5a on the dielectric waveguide 1 side is coupled in a state where it is press-bonded on a side surface of the dielectric waveguide 1, and the other end of the central conductor 5a on a strip 4a side is connected with a strip 4a.

A dielectric material 4b is provided on the metal rod 3, and the strip 4a having a strip shape is formed on this dielectric material 4b, thereby realizing the microstrip line 4. The microstrip line 4 is realized by the dielectric material 4b having, e.g., a substrate thickness of 0.2 mm and a relative dielectric constant εr=2.3 and the strip 4a having a line width of 0.5 mm. The strip 4a is earthed with respect to the metal rod 3 at a position which is λ/4 away from a coupling point between itself and the central conductor 5a.

A length of the central conductor 5a between the metal rod 3 and the dielectric waveguide 1 can be set to, e.g., λ/4, and it may be generally set to λ/4+n·(λ/2). It is to be noted that n is 0, 1, 2, . . . , i.e., an integer including 0. Furthermore, the metal rod 3 has an H cross-sectional shape, a length of each side thereof in a direction of the central conductor 5a is set to a ¼ wavelength, and the metal rod 3 has a choke structure which prevents an electric wave in an operating frequency band between the dielectric waveguide 1 side and the microstrip line 4 side from leaking.

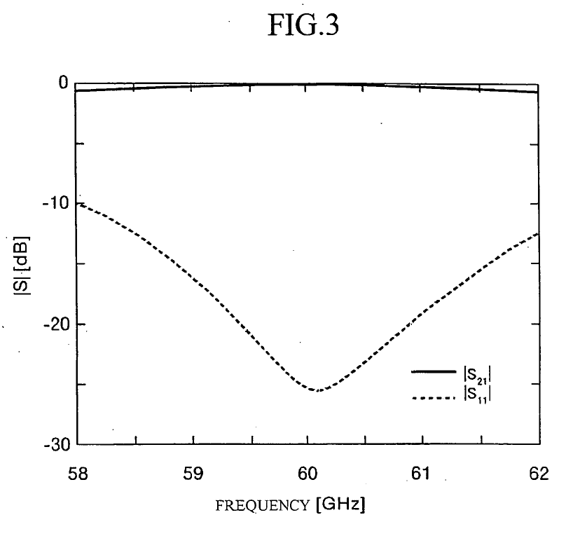

FIG. 3 is a view showing frequency characteristics of an output |s₂₁| of a power input from a port P1 to a port P2 of the NRD guide transition depicted in FIGS. 1 and 2 and a return loss |s₁₁| at the port P1. As shown in FIG. 3, the return loss |s₁₁| is not greater than 20 dB in a 2-GHz band with 60 GHz at the center, and the output |s₂₁| from the dielectric waveguide 1 to the microstrip line 4 through the coaxial line 5 is an efficient transition output. That is, a transition between the dielectric waveguide 1 and the microstrip line 4, which can satisfactorily come into practical use, is realized.

### Embodiment 2

Embodiment 2 according to the present invention will now be described. Although one dielectric waveguide 1 and one microstrip line 4 are coupled with each other in Embodiment 1 mentioned above, a dielectric waveguide is coupled with each of both ends of a microstrip line in this Embodiment 2.

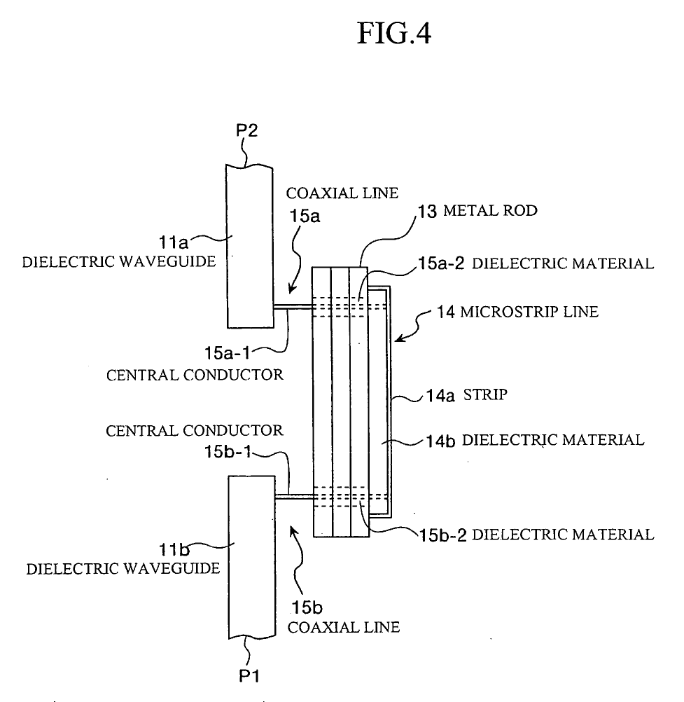

FIG. 4 is a plan view showing a primary part of an NRD guide transition according to Embodiment 2 of the present invention. As shown in FIG. 4, coaxial lines 15a and 15b corresponding to the coaxial line 5 are formed at both ends of a strip 14a of a microstrip line 14, and they are respectively connected with dielectric waveguides 11a and 11b. It is to be noted that central conductors 15a-1 and 15b-1 correspond to the central conductor 5a, a dielectric material 14b corresponds to the dielectric material 4b, and dielectric materials 15a-2 and 15b-2 correspond to the dielectric material 5b.

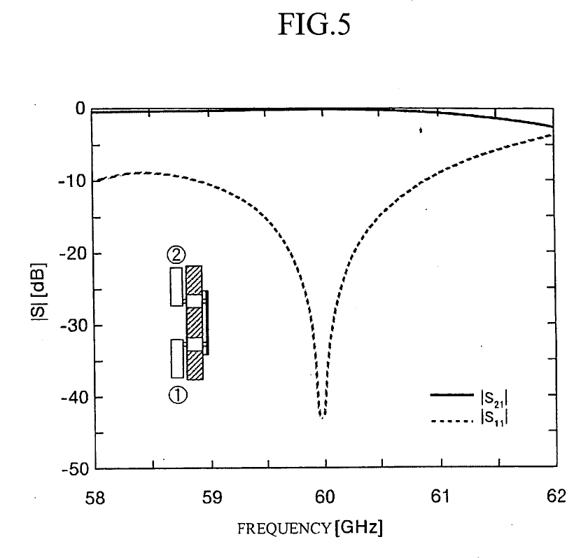

FIG. 5 is a view showing frequency characteristics of an output |s₂₁| of a power input from a port P1 to a port P2 and a return loss |s₁₁|, at the port P1 of the NRD guide transition depicted in FIG. 4. It is to be noted that the port P1 is a port on the dielectric waveguide 11b side, and the port P2 is a port on the dielectric waveguide 11a side. As shown in FIG. 5, the return loss |s₁₁|, is not greater than approximately 10 dB in a 2-GHz band with 60 GHz at the center, and the output |s₂₁| from the dielectric waveguide 11b to the dielectric waveguide 11a through the coaxial line 15b, the microstrip line 14 and the coaxial line 15a is an efficient conversion output.

In this Embodiment 2, the microstrip line 14 can be used as a mount of a three-terminal device.

### Embodiment 3

Although the side surface of the metal rod 3 or 13 is effectively utilized and the microstrip line 4 or 14 is provided on this side surface in order to effectively use a space formed between the conductor plates 2a and 2b in the above-described Embodiments 1 and 2, an NRD guide transition which can obtain a larger loading surface is realized in this Embodiment 3.

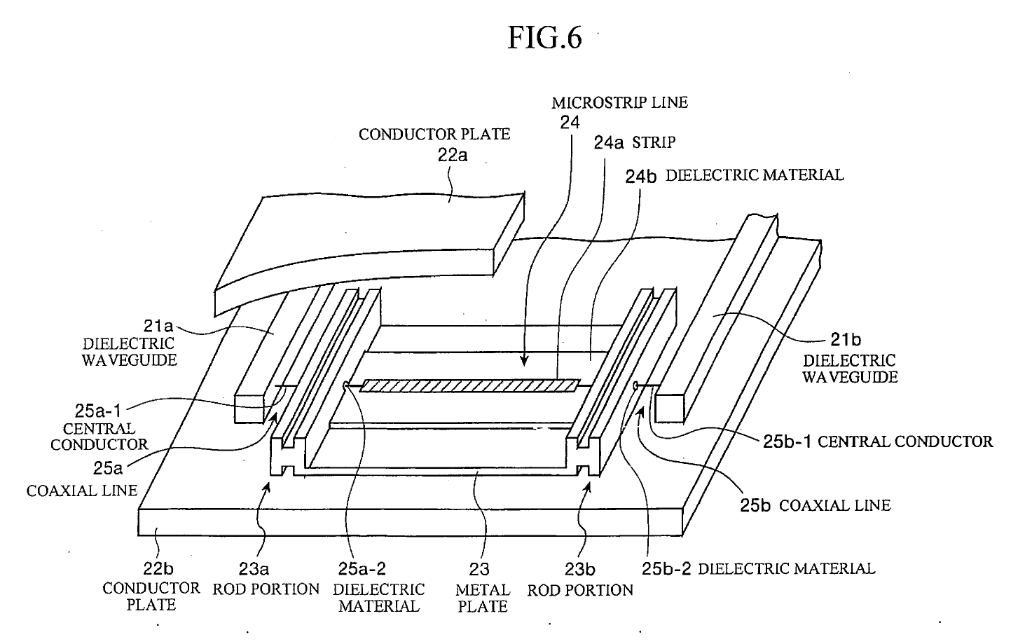

FIG. 6 is a partially cutaway perspective view showing an NRD guide transition according to Embodiment 3 of the present invention. In FIG. 6, this NRD guide transition has two dielectric waveguides 21a and 21b held between conductor plates 22a and 22b, and these dielectric waveguides correspond to the dielectric waveguides 1, 11a and 11b. A metal plate 23 having rod portions 23a and 23b corresponding to the metal rods 3 and 13 is provided between the dielectric waveguides 21a and 21b. Further, a dielectric material 24b is formed on a concave portion at the center of the metal plate 23, and a strip 24a is further provided thereon. That is, the central concave portion, the dielectric material 24b and the strip 24a form a microstrip line 24.

Dielectric materials 25a-2 and 25b-2 corresponding to the dielectric material 5b are provided at the center of the rod portions 23a and 23b, and central conductors 25a-1 and 25b-1 corresponding to the central conductor 5a are provided so as to pierce the dielectric materials 25a-2 and 25b-2. The central conductors 25a-1 and 25b-1 are connected with both ends of the strip 24a and also pressure-bonded on side surfaces of the dielectric waveguides 21a and 21b, respectively. That is, the dielectric waveguides 21a and 21b are coupled and connected with the microstrip line 24 through coaxial lines 25a and 25b corresponding to the coaxial line 5.

Here, since the central concave portion of the metal plate 23 forms a plane parallel with the conductor plates 22a and 22b, the microstrip line 24 having a large loading area can be formed. That is, the NRD guide transition according to this Embodiment 3 can be used for the microstrip line 24, which requires a large circuit area.

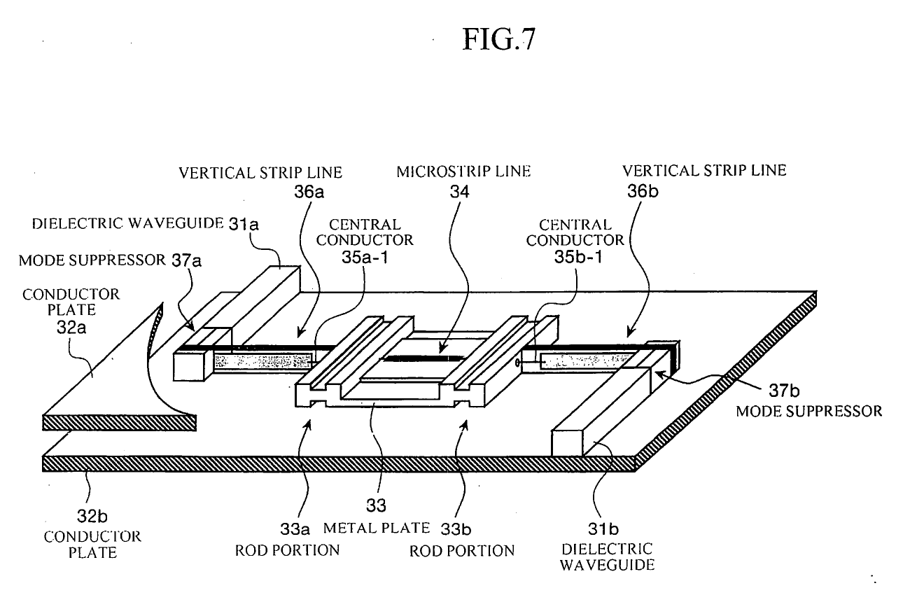

FIG. 7 is a partially cutaway perspective view showing a modification of the NRD guide transition depicted in FIG. 6. In this NRD guide transition, central conductors 35a-1 and 35b-1 are not directly connected with dielectric waveguides 31a and 31b, but vertical strip lines 36a and 36b are interposed to connect these members. Interposition of these vertical strip lines 36a and 36b provide mode suppressors 37a and 37b, which suppress an LSE mode which is an unnecessary parasitic mode at coupling parts of the dielectric waveguides 31a and 31b. The vertical strip lines 36a and 36b physically set the dielectric waveguides 31a and 31b apart from rod portions 33a and 33b, reduce an influence of an operating mode electric wave on the dielectric waveguides 31a and 31b from the vicinity of the coupling parts, and couple the dielectric waveguides 31a and 31b with the central conductors 35a-1 and 35b-l with a low loss.

In this Embodiment 3, formation of the microstrip line requiring a large loading area can be realized with a low loss.

As described above, according to the present invention, there can be obtained an effect of readily realizing a hybrid structure in which the dielectric waveguides having a very low loss can be connected with the microstrip line capable of realizing a flexible circuit configuration through the coaxial lines piercing the conductor rods, the dielectric waveguides are used for the transmission parts and the microstrip line is used for the circuit element loading part.

Furthermore, according to the present invention, since the first dielectric waveguide, the microstrip line and the second dielectric waveguide are cascade-connected, there can be obtained an effect of realizing a hybrid structure in which a three-terminal circuit can be loaded on the microstrip line.

Moreover, according to the present invention, there can be obtained an effect of realizing a hybrid structure in which the microstrip line is provided between the first and second conductor rods and the microstrip line which forms a plane parallel with the parallel conductor plates and has a large loading area is mounted, for example.

Additionally, the present invention can demonstrate an effect of realizing a hybrid structure in which the first and second vertical strip lines respectively set the first and second conductor rods apart from the first and second dielectric waveguides, thereby reducing disturbances of an electric wave with respect to the first and second dielectric waveguides.

Further, according to the present invention, there can be obtained an effect of realizing a high-performance hybrid structure since the dielectric waveguide side is electrically separated from the microstrip side.

### Embodiment 4

Embodiment 4 according to the present invention will now be described. In this Embodiment 4, a description will be given on an example where a microstrip line is coupled with a coaxial line. In particular, this Embodiment 4 can be applied to Embodiment 1 or the like mentioned above to prevent a transmission loss from being further deteriorated.

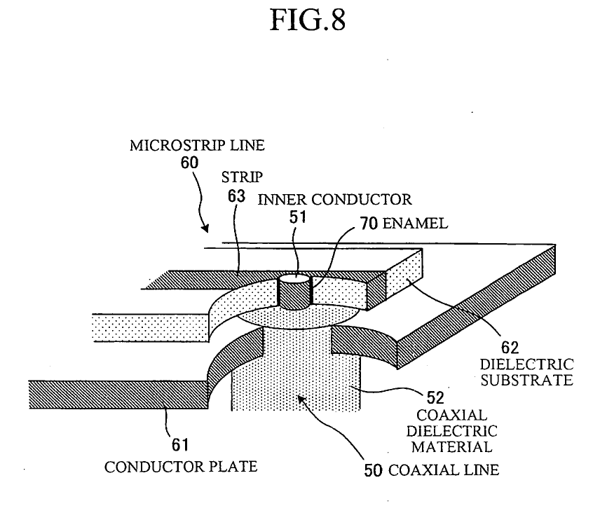

FIG. 8 is a partially cutaway view obliquely showing a coupling structure of a microstrip line and a coaxial line according to Embodiment 4 of the present invention. As shown in FIG. 8, in a microstrip line 60, a strip 63 is formed on a conductor plate 61 through a dielectric substrate 62. In a coaxial line 50 coupled with this microstrip line 63, a coaxial dielectric material 52 pieces the conductor plate, and an inner conductor 51 in the coaxial dielectric material 52 further pieces the dielectric substrate 62 to be coupled with a strip 63. In this case, the conductor plate 61 functions as an external conductor.

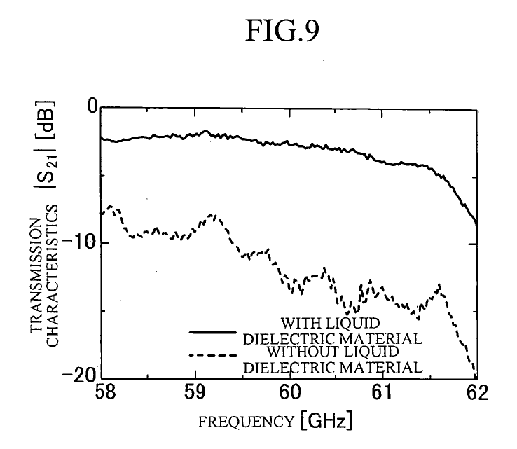

Here, it is difficult to form a structure, which does not have an air gap at all between the inner conductor 51 and the dielectric substrate 62, and transmission characteristics are deteriorated as indicated by a broken line in FIG. 9. Thus, when enamel 70 is filled in order to completely eliminate the air gap between the inner conductor 51 and the dielectric substrate 62, the characteristics can be improved 5 dB or more as indicated by a solid line in FIG. 9.

Filling the air gap generated at a position where an electromagnetic field distribution is intensive in this manner can assuredly obtain the designed characteristics as the transmission characteristics. It is to be noted that the transmission characteristics indicated by a solid line demonstrates a loss of approximately 2 dB even though the enamel 70 is filled, but this loss is not a loss caused due to transition between the microstrip line 60 and the coaxial line 50 but a transmission loss of the microstrip line 60 itself.

According to this Embodiment 4, even if the microstrip line 60 and the coaxial line 50 are simply coupled with each other, the air gap produced between the dielectric substrate 62 and the inner conductor 51 at which an electromagnetic field is concentrated can be filled with the enamel 70 to thereby eliminate deterioration in the transmission characteristics.

### Embodiment 5

This embodiment 5 is obtained by applying the method of filling a liquid dielectric material according to Embodiment 4 to an NRD guide mode suppressor.

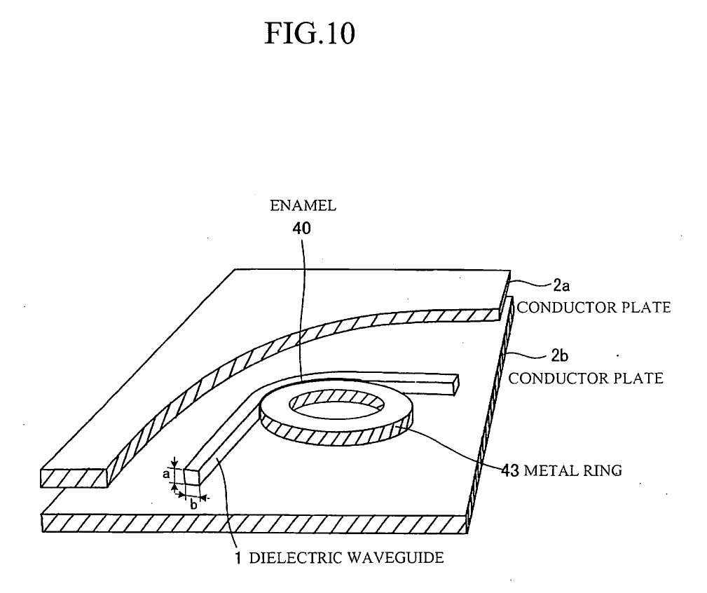

FIG. 10 is a partially cutaway view obliquely showing a general configuration of an NRD guide mode suppressor according to Embodiment 5 of the present invention. In FIG. 10, this NRD guide mode suppressor has a dielectric waveguide 1 sandwiched between parallel conductor plates 2a and 2b. The dielectric waveguide 1 is realized by using Teflon (R) having a relative dielectric constant εr=2.04 and tan δ=approximately 1.5×10⁻⁴, and has a height a of 2.25 mm and a width b of 2.5 mm. Assuming that an operating frequency of an electromagnetic wave propagated through the dielectric waveguide 1 is 60 GHz, its wavelength λ is approximately 5 mm, its height a is less than λ/2, and a millimeter wave having the operating frequency is not propagated between the conductor plates 2a and 2b excluding the dielectric waveguide 1. On the contrary, in the dielectric waveguide 1, the wavelength λ is reduced, and the millimeter wave having the operating frequency can be propagated. As a result, it is possible to form an NRD guide in which the millimeter wave can be propagated through the dielectric waveguide 1 alone in an operating frequency band.

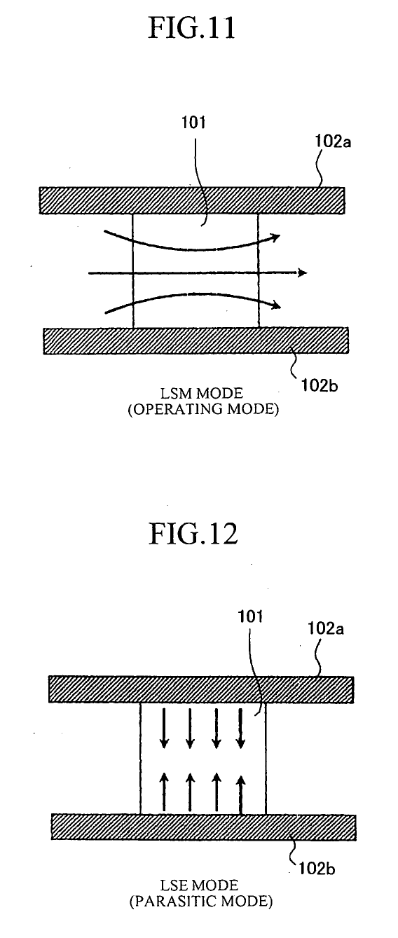

Here, the dielectric waveguide 1 has a configuration which is bent with a curvature radius R=12 mm and, in this case, as shown in FIGS. 11 and 12, an LSE mode which is a parasitic mode is generated besides an LSM mode which is an operating mode. Here, when a metal ring 43, which is a conductor, is appressed against a bent inner side of the dielectric waveguide 1, the LSE mode is suppressed. In order to set this metal ring 43 to be appressed against the dielectric waveguide 1, enamel 40 as a liquid dielectric material having dry curing properties is filled between the metal ring 43 and the dielectric waveguide 1 to achieve close contact.

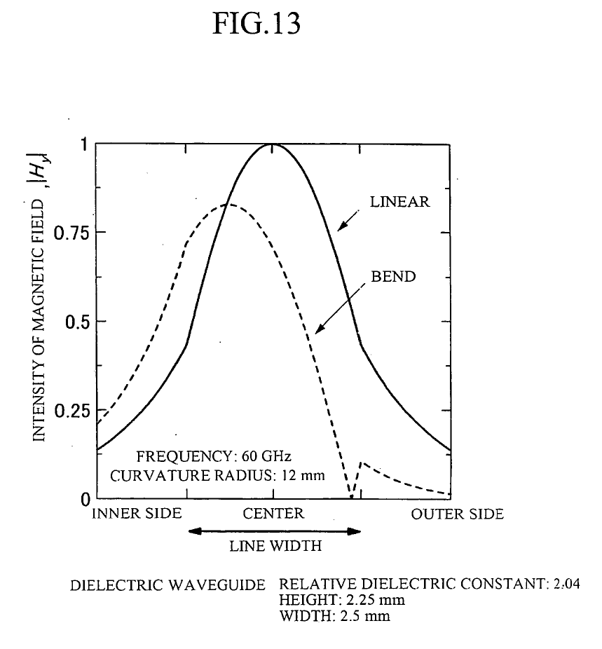

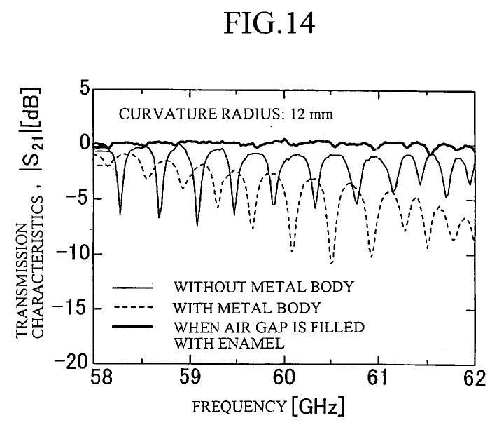

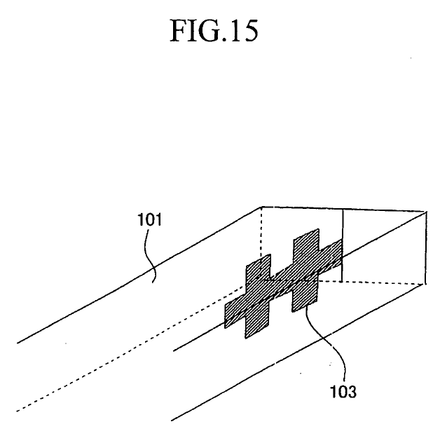

As shown in FIG. 13, when the dielectric waveguide 1 is bent as compared with an example where the dielectric waveguide 1 is straight, an electromagnetic field is shifted toward a bent inner side, and electromagnetic field intensity on the bent inner side is increased. Here, as shown in FIG. 14, spike-like deterioration is generated due to an increase in the electromagnetic field intensity as well as the air gap produced between the dielectric waveguide 1 and the metal ring 43, but filling the enamel 40 can eliminate this spike-like deterioration. That is, although design and manufacture are carried out so as not to produce the air gap between the dielectric waveguide 1 and the metal ring 43, removing existence of this small air gap is difficult, and filling the enamel 40 can eliminate an influence of this air gap.

According to this Embodiment 5, the air gap generated between the dielectric material 1 and the metal ring 43 can be assuredly removed by filling the enamel 40, whereby spike-like deterioration of transmission characteristics can be securely eliminated. It is to be noted that the enamel 40 is the liquid dielectric material having dry curing properties, but the present invention is not restricted thereto, any liquid dielectric material can suffice, and oil can be used. However, a material having curing and adhesion properties like the enamel 40 is preferable.

It is to be noted that the description has been given as to coupling of the microstrip line and the coaxial line and the example of the NRD guide suppressor in Embodiments 4 and 5, but the present invention is not restricted thereto, and it can be applied to all configurations which closely couple a dielectric material with a metal (conductor) to eliminate an air gap. For example, in FIG. 8, the present invention can be likewise applied between the dielectric substrate 62 and the conductor plate 61 to readily completely eliminate a gap, thereby demonstrating an effect in an improvement of transmission characteristics.

### INDUSTRIAL APPLICABILITY

As described above, the NRD guide transition according to the present invention can readily realize a hybrid structure in which the dielectric waveguide having a very low loss is connected with the microstrip line capable of realizing a flexible circuit configuration through the coaxial line piercing the conductor rod, the dielectric waveguide is used for a transmission part and the microstrip line is used for a circuit element loading part, and hence the present invention can be applied to an ultrahigh-speed wireless LAN, a home link, indoor TV wireless transfer and an inter-vehicle communication system. Further, the coupling structure of the dielectric material and the conductor realized by filling the liquid dielectric material according to the present invention can be applied to all structures which sets the dielectric material to be appressed against the conductor in order to couple them with each other, and general communication devices which avoid deterioration of transmission characteristics in particular.

1-20. (canceled)

21. An NRD guide transition comprising:
a dielectric waveguide which is sandwiched between parallel conductors and has a gap which is less than a ½ wavelength; a conductor rod which is adjacently arranged in substantially parallel with the dielectric waveguide; a microstrip line having a side surface opposite to the dielectric waveguide determined as a ground conductor with respect to the conductor rod; and
a coaxial line which pierces the conductor rod and a dielectric substrate of the microstrip line in a direction perpendicular to a longitudinal direction of the conductor rod and in parallel with the parallel conductors, and connects the dielectric waveguide with the microstrip line.

22. An NRD guide transition comprising:
a first dielectric waveguide which is sandwiched between parallel conductor plates and has a gap which is less than a ½ wavelength;
a second dielectric waveguide which is cascade-arranged with respect to the first dielectric waveguide in a longitudinal direction with a desired gap therebetween; a conductor rod adjacently arranged in substantially parallel with the first and second dielectric waveguides; a microstrip line having a side surface opposite to the first and second dielectric waveguides determined as a ground conductor with respect to the conductor rod;
a first coaxial line which pierces the conductor rod and a dielectric substrate of the microstrip line in the vicinity of one end portion of the conductor rod in a direction perpendicular to a longitudinal direction of the conductor rod and in parallel with the parallel conductor plates, and connects the first dielectric waveguide with the vicinity of one end portion of the microstrip line; and
a second coaxial line which pierces the conductor rod and a dielectric substrate of the microstrip line in the vicinity of the other end portion of the conductor rod in a direction perpendicular to a longitudinal direction of the conductor rod and in parallel with the parallel conductor plates, and connects the second dielectric waveguide with the vicinity of the other end portion of the microstrip line,
wherein the first dielectric waveguide, the microstrip line and the second dielectric waveguide are cascade-connected.

23. An NRD guide transition comprising:
first and second dielectric waveguides each of which is sandwiched between parallel conductor plates and has a gap which is less than a ½ wavelength;
first and second conductor rods which are provided between the first and second dielectric waveguides and arranged in substantially parallel with the first and second dielectric waveguides;
a microstrip line provided between the first and second conductor rods;
a first coaxial line which pierces the conductor rod in a direction perpendicular to a longitudinal direction of the first conductor rod and in parallel with the parallel conductor plates, and connects the first dielectric waveguide with one end of the microstrip line; and
a second coaxial line which pierces the conductor rod in a direction perpendicular to a longitudinal direction of the second conductor rod and in parallel with the parallel conductor plates, and connects the second dielectric waveguide with the other end of the microstrip line,
wherein the first dielectric waveguide, the microstrip line and the second dielectric waveguide are cascade-connected.

24. The NRD guide transition according to claim 23, further comprising:
a first vertical strip line which connects one end of the first coaxial line connected with the first dielectric waveguide to the first dielectric waveguide; and
a second vertical strip line which connects one end of the second coaxial line connected with the second dielectric waveguide to the second dielectric waveguide.

25. The NRD guide transition according to claim 21, wherein a lateral width of a contact surface of each of the conductor rod, the first conductor rod and the second conductor rod with respect to each of the parallel conductor plates is a ¾ wavelength, and a groove having a width of a ¼ wavelength is provided at a central part of the contact surface in a longitudinal direction to form a choke structure.

26. The NRD guide transition according to claim 21, wherein a liquid dielectric material is filled in an air gap formed between contact surfaces of a dielectric substrate of the microstrip line and a cylindrical dielectric material constituting the coaxial line and an air gap formed between contact surfaces of the dielectric substrate of the microstrip line and the conductor rod.

27. The NRD guide transition according to claim 26, wherein the liquid dielectric material is a liquid dielectric material having dry curing properties.

28. The NRD guide transition according to claim 27, wherein the liquid dielectric material having dry curing properties is enamel.

29. The NRD guide transition according to claim 22, wherein a liquid dielectric material is filled in a gap formed between contact surfaces of a cylindrical dielectric material constituting the first coaxial line, a cylindrical dielectric material constituting the second coaxial line and the dielectric substrate of the microstrip line.

30. The NRD guide transition according to claim 29, wherein the liquid dielectric material is a liquid dielectric material having dry curing properties.

31. The NRD guide transition according to claim 30, wherein the liquid dielectric material having dry curing properties is enamel.

32. The NRD guide transition according to claim 23, wherein a liquid dielectric material is filled in an air gap formed between contact surfaces of a cylindrical dielectric material constituting the first coaxial line, a cylindrical dielectric material constituting the second coaxial line and the dielectric substrate of the microstrip line.

33. The NRD guide transition according to claim 32, wherein the liquid dielectric material is a liquid dielectric material having dry curing properties.

34. The NRD guide transition according to claim 33, wherein the liquid dielectric material having dry curing properties is enamel.

35. A small NRD guide bend, wherein a conductor is arranged to be appressed against a bent portion of a dielectric waveguide of an NRD guide, and a liquid dielectric material is filled in an air gap formed between contact surfaces of the dielectric waveguide and the conductor, the dielectric waveguide being sandwiched between parallel conductor plates and having a gap which is less than a ½ wavelength, the NRD guide propagating an electromagnetic wave through the dielectric waveguide.

36. A coupling structure of a dielectric material and a conductor according to claim 35, wherein the liquid dielectric material is a liquid dielectric material having dry curing properties.

37. The NRD guide transition according to claim 22, wherein a lateral width of a contact surface of each of the conductor rod, the first conductor rod and the second conductor rod with respect to each of the parallel conductor plates is a ¾ wavelength, and a groove having a width of a ¼ wavelength is provided at a central part of the contact surface in a longitudinal direction to form a choke structure.

38. The NRD guide transition according to claim 23, wherein a lateral width of a contact surface of each of the conductor rod, the first conductor rod and the second conductor rod with respect to each of the parallel conductor plates is a ¾ wavelength, and a groove having a width of a ¼ wavelength is provided at a central part of the contact surface in a longitudinal direction to form a choke structure.

39. The NRD guide transition according to claim 24, wherein a lateral width of a contact surface of each of the conductor rod, the first conductor rod and the second conductor rod with respect to each of the parallel conductor plates is a ¾ wavelength, and a groove having a width of a ¼ wavelength is provided at a central part of the contact surface in a longitudinal direction to form a choke structure.
